(19) United States
(12) Patent Application Publication
(10) Pub. No.: US 2025/0036511 A1
(43) Pub. Date: Jan. 30, 2025

(54) FAULT MONITORING METHOD AND APPARATUS FOR SINTERING DEVICE

(71) Applicants: ZHUZHOU RUIDEER INTELLIGENT EQUIPMENT CO., LTD., Zhuzhou (CN); HUNAN LINGXIN NEW MATERIALS CO., LTD., Changsha (CN)

(72) Inventors: Simin Zou, Zhuzhou (CN); Zhen Liu, Zhuzhou (CN); Junguang Xiao, Zhuzhou (CN); Ping Tan, Zhuzhou (CN)

(73) Assignees: ZHUZHOU RUIDEER INTELLIGENT EQUIPMENT CO., LTD., Zhuzhou, HU (CN); HUNAN LINGXIN NEW MATERIALS CO., LTD., Changsha, HU (CN)

(21) Appl. No.: 18/716,032

(22) PCT Filed: Dec. 21, 2021
(86) PCT No.: PCT/CN2021/139853

§ 371 Date: Jun. 3, 2024

(30) Foreign Application Priority Data
Dec. 3, 2021 (CN) 202111470334.1

(51) Int. Cl. G06F 11/07

(52) U.S. Cl. CPC G06F 11/079; G06F 11/0736

(57) ABSTRACT

A fault monitoring method and apparatus for a sintering device are provided. The method comprises: acquiring state monitoring information and state threshold information; processing the state monitoring information by using a predetermined state prediction rule, to obtain predicted state information; and processing the predicted state information and the state threshold information by using a predetermined fault evaluation rule, to obtain fault state information, wherein the fault state information is used for instructing to perform intelligent operation and maintenance of a sintering device. It can be seen that, state monitoring information can be processed by using a state prediction rule, such that predicted state information is obtained; and the predicted state information and state threshold information are then comprehensively processed by means of a fault evaluation rule, such that fault state information is used for instructing to perform intelligent operation and maintenance of a sintering device.

### CROSS-REFERENCE TO RELATED APPLICATION

This application is a national stage of International Application No. PCT/CN2021/139853, filed on Dec. 21, 2021, which claims priority to Chinese Patent Application No. 202111470334.1, filed on Dec. 3, 2021. Both of the aforementioned applications are hereby incorporated by reference in their entireties.

### TECHNICAL FIELD

The present disclosure relates to the technical field of fault monitoring, in particular to a fault monitoring method and apparatus for a sintering device.

### BACKGROUND

At present, equipment health management technology has been paid more and more attention, especially in the key monitoring data of a sintering device. Data closely related to the equipment health state includes temperature data and vibration data. Based on the operation data of a sintering device, a statistical analysis method is often used to monitor a fault of a sintering device. Although it is easy to implement the method, the method is significantly limited and overly relies on manual experience. The accuracy of evaluation results depends highly on the professional experience of evaluators, so that it is difficult to precisely detect an operation state of a sintering device. Therefore, it is particularly important to provide a fault monitoring method and an apparatus for a sintering device, so as to realize the precise detection of the operating state of the sintering device and the early warning of a fault in the sintering device, thereby improving the guarantee capability for the intelligent maintenance of the sintering device and the stable operation of the sintering device.

### SUMMARY

The purpose of the present disclosure is to provide a fault monitoring method and apparatus for a sintering device, which can process state monitoring information by using a state prediction rule to obtain prediction state information, and then comprehensively process the prediction state information and state threshold information by using a fault evaluation rule to obtain fault state information used for instructing to perform intelligent operation and maintenance of the sintering device, which facilitates the precise detection of the operating state of the sintering device and the early warning of a fault in the sintering device, thereby improving the guarantee capability for the intelligent maintenance of the sintering device and the stable operation of the sintering device.

In order to solve the above technical problem, a first aspect of an embodiment of the present disclosure provides a fault monitoring method for a sintering device, wherein the method includes:
acquiring state monitoring information and state threshold information;
processing the state monitoring information by using a predetermined state prediction rule to obtain prediction state information; and
processing the prediction state information and the state threshold information by using a predetermined fault evaluation rule to obtain fault state information; where the fault state information is used for instructing to perform intelligent operation and maintenance of a sintering device.

As an alternative implementation, in the first aspect of the embodiment of the present disclosure, the state monitoring information includes first time sequence information and actually measured state information;
the processing the state monitoring information by using a predetermined state prediction rule to obtain prediction state information includes:
processing the first time sequence information by using a predetermined first prediction model to obtain a first prediction information set; where the first prediction information set includes a plurality of first prediction information;
processing the first time sequence information by using a predetermined second prediction model to obtain a second prediction information set; where the second prediction information set includes a plurality of second prediction information;
processing the first prediction information set, the second prediction information set and the actually measured state information to obtain a weight coefficient set; where the weight coefficient set includes a first weight coefficient and a second weight coefficient; and
determining the prediction state information according to the first prediction model, the second prediction model and the weight coefficient set.

As an alternative implementation, in the first aspect of the embodiment of the present disclosure, the processing the first prediction information set, the second prediction information set and the actually measured state information to obtain a weight coefficient set includes:
processing the first prediction information set and the actually measured state information by using a predetermined precision calculation model to obtain a first prediction precision set; where the first prediction precision set includes a plurality of first prediction precision;
processing the second prediction information set and the actually measured state information by using the precision calculation model to obtain a second prediction precision set; where the second prediction precision set includes a plurality of second prediction precision;
calculating the first prediction precision set, the first prediction information set, the second prediction precision set and the second prediction information set by using a predetermined combined prediction precision model to obtain combined prediction information;
processing the combined prediction information and the actually measured state information to obtain a weight coefficient set.

As an alternative implementation, in the first aspect of the embodiment of the present disclosure, the processing the combined prediction information and the actually measured state information to obtain a weight coefficient set includes:
performing error calculation on the combined prediction information and the actually measured state information to obtain error value information;
processing the error value information by using a predetermined minimum value solving rule to obtain a weight coefficient set.

As an alternative implementation, in the first aspect of the embodiment of the present disclosure, the state threshold information includes second time sequence information;
the determining the prediction state information according to the first prediction model, the second prediction model and the weight coefficient set includes:
processing the second time sequence information by using the first prediction model to obtain a first state information set; where the first state information set includes a plurality of first state information;
processing the second time sequence information by using the second prediction model to obtain a second state information set; where the second state information set includes a plurality of second state information; and
processing the weight coefficient set, the first state information set and the second state information set to obtain the prediction state information.

As an alternative implementation, in the first aspect of the embodiment of the present disclosure, the state threshold information includes state reference information and determination threshold information;
the processing the prediction state information and the state threshold information by using a predetermined fault evaluation rule to obtain fault state information includes:
processing the prediction state information and the state reference information to obtain a residual value information set; where the residual value information set includes a plurality of residual value information; and
determining the fault state information according to the determination threshold information and the residual value information set.

As an alternative implementation, in the first aspect of the embodiment of the present disclosure, the determination threshold information includes a first threshold value, a second threshold value and a time sequence interval;
the determining the fault state information according to the determination threshold information and the residual value information set includes:
calculating the state reference information and the residual value information set to obtain a multiple value set; where the multiple value set includes a plurality of multiple values;
for any residual value information, determining whether the multiple value corresponding to the residual value information is greater than or equal to the first threshold value to obtain a first determination result;
when the first determination result is YES, determining the fault state information according to the second time sequence information corresponding to the residual value information, and ending current process;
when the first determination result is NO, determining the number of residual values corresponding to the residual value information according to the time sequence interval and the second time sequence information corresponding to the residual value information;
determining whether the number of residual values corresponding to the residual value information is greater than or equal to the second threshold value to obtain a second determination result; and
when the second determination result is YES, determining the fault state information according to the second time sequence information corresponding to the residual value information.

A second aspect of the embodiment of the present disclosure provides a fault monitoring apparatus for a sintering device, where the apparatus includes:
an acquiring module, configured to acquire state monitoring information and state threshold information;
a first processing module, configured to process the state monitoring information by using a predetermined state prediction rule to obtain prediction state information; and
a second processing module, configured to process the prediction state information and the state threshold information by using a predetermined fault evaluation rule to obtain fault state information; where the fault state information is used for instructing to perform intelligent operation and maintenance of a sintering device.

As an alternative implementation, in the second aspect of the embodiment of the present disclosure, the state monitoring information includes first time sequence information and actually measured state information;
the first processing module configured to process the state monitoring information by using a predetermined state prediction rule to obtain prediction state information, is configured to:
process the first time sequence information by using a predetermined first prediction model to obtain a first prediction information set; where the first prediction information set includes a plurality of first prediction information;
process the first time sequence information by using a predetermined second prediction model to obtain a second prediction information set; where the second prediction information set includes a plurality of second prediction information;
process the first prediction information set, the second prediction information set and the actually measured state information to obtain a weight coefficient set; where the weight coefficient set includes a first weight coefficient and a second weight coefficient; and
determine the prediction state information according to the first prediction model, the second prediction model and the weight coefficient set.

As an alternative implementation, in the second aspect of the embodiment of the present disclosure, the first processing module configured to processes the first prediction information set, the second prediction information set and the actually measured state information to obtain a weight coefficient set, is configured to:
process the first prediction information set and the actually measured state information by using a predetermined precision calculation model to obtain a first prediction precision set; where the first prediction precision set includes a plurality of first prediction precision;
process the second prediction information set and the actually measured state information by using the precision calculation model to obtain a second prediction precision set; where the second prediction precision set includes a plurality of second prediction precision;
calculate the first prediction precision set, the first prediction information set, the second prediction precision set and the second prediction information set by using a predetermined combined prediction precision model to obtain combined prediction information;
process the combined prediction information and the actually measured state information to obtain a weight coefficient set.

As an alternative implementation, in the second aspect of the embodiment of the present disclosure, the first processing module configured to process the combined prediction information and the actually measured state information to obtain a weight coefficient set, is configured to:
perform error calculation on the combined prediction information and the actually measured state information to obtain error value information;
process the error value information by using a predetermined minimum value solving rule to obtain a weight coefficient set.

As an alternative implementation, in the second aspect of the embodiment of the present disclosure, the state threshold information includes second time sequence information;
the first processing module configured to determine the prediction state information according to the first prediction model, the second prediction model and the weight coefficient set, is configured to:
process the second time sequence information by using the first prediction model to obtain a first state information set; where the first state information set includes a plurality of first state information;
process the second time sequence information by using the second prediction model to obtain a second state information set; where the second state information set includes a plurality of second state information; and
process the weight coefficient set, the first state information set and the second state information set to obtain prediction state information.

As an alternative implementation, in the second aspect of the embodiment of the present disclosure, the state threshold information includes state reference information and determination threshold information;
the second processing module includes a processing sub-module and a determining sub-module, where:
the processing sub-module is configured to process the prediction state information and the state reference information to obtain a residual value information set; where the residual value information set includes a plurality of residual value information;
the determining sub-module is configured to determine the fault state information according to the determination threshold information and the residual value information set.

As an alternative implementation, in the second aspect of the embodiment of the present disclosure, the determination threshold information includes a first threshold value, a second threshold value and a time sequence interval;
the determining sub-module configured to determine the fault state information according to the determination threshold information and the residual value information set, is configured to:
calculate the state reference information and the residual value information set to obtain a multiple value set; where the multiple value set includes a plurality of multiple values;
for any residual value information, determine whether the multiple value corresponding to the residual value information is greater than or equal to the first threshold value to obtain a first determination result;
when the first determination result is YES, determine the fault state information according to the second time sequence information corresponding to the residual value information, and end current process;
when the first determination result is NO, determine the number of residual values corresponding to the residual value information according to the time sequence interval and the second time sequence information corresponding to the residual value information;
determine whether the number of residual values corresponding to the residual value information is greater than or equal to the second threshold value to obtain a second determination result; and
when the second determination result is YES, determine the fault state information according to the second time sequence information corresponding to the residual value information.

A third aspect of the embodiment of the present disclosure provides another fault monitoring apparatus for a sintering device, wherein the apparatus includes:
a memory, in which an executable program code is stored;
a processor, which is coupled to the memory;
where the processor calls the executable program code stored in the memory to execute part or all of steps in the fault monitoring method for the sintering device provided in the first aspect of the embodiment of the present disclosure.

A fourth aspect of the embodiment of the present disclosure provides a computer-storable medium, where the computer-storable medium stores computer instructions which, when called, are used to execute part or all of steps in the fault monitoring method for the sintering device provided in the first aspect of the embodiment of the present disclosure.

Compared with the prior art, the embodiment of the present disclosure has the following beneficial effects.

In the embodiment of the present disclosure, state monitoring information and state threshold information are acquired; the state monitoring information is processed by using a predetermined state prediction rule to obtain prediction state information; and the prediction state information and the state threshold information are processed by using a predetermined fault evaluation rule to obtain fault state information; where the fault state information is used for instructing to perform intelligent operation and maintenance of a sintering device. It can be seen that the method according to the embodiment of the present disclosure can process the state monitoring information by using the state prediction rule to obtain the prediction state information, and then comprehensively process the prediction state information and the state threshold information by using the fault evaluation rule to obtain the fault state information used for instructing to perform intelligent operation and maintenance of the sintering device, which facilitates the precise detection of the operating state of the sintering device and the early warning of a fault in the sintering device, thereby improving the guarantee capability for the intelligent maintenance of the sintering device and the stable operation of the sintering device.

### BRIEF DESCRIPTION OF THE DRAWINGS

In order to explain the technical scheme in the embodiment of the present disclosure more clearly, the drawings that need to be used in the embodiments will be briefly introduced hereinafter. Obviously, the drawings in the following description are only some embodiments of the present disclosure. For those skilled in the art, other drawings can be obtained according to these drawings without creative labor.

FIG. 1 is a flow schematic diagram of a fault monitoring method for a sintering device according to an embodiment of the present disclosure.

FIG. 2 is a flow schematic diagram of another fault monitoring method for a sintering device according to an embodiment of the present disclosure.

FIG. 3 is a schematic structural diagram of a fault monitoring apparatus for a sintering device according to an embodiment of the present disclosure.

FIG. 4 is a schematic structural diagram of another fault monitoring apparatus for a sintering device according to an embodiment of the present disclosure.

FIG. 5 is a schematic structural diagram of still another fault monitoring apparatus for a sintering device according to an embodiment of the present disclosure.

### DETAILED DESCRIPTION OF THE EMBODIMENTS

In order to make those skilled in the art better understand the scheme of the present disclosure, the technical schemes in the embodiments of the present disclosure will be clearly and completely described with reference to the drawings in the embodiments of the present disclosure hereinafter. Obviously, the described embodiments are only some embodiments of the present disclosure, rather than all of the embodiments. Based on the embodiment of the present disclosure, all other embodiments obtained by those skilled in the art without creative labor fall within the scope of protection of the present disclosure.

The terms “first” and “second” in the description and claims of the present disclosure and the above drawings are used to distinguish different objects, rather than describe a specific order. Furthermore, the terms “include” and “have” and any variations thereof are intended to cover non-exclusive inclusion. For example, a process, a method, an apparatus, a product or a device that includes a series of steps or units is not limited to the listed steps or units, but alternatively includes steps or units that are not listed, or alternatively includes other steps or units that are inherent to the process, method, product or device.

Reference to an “embodiment” herein means that a particular feature, structure or characteristic described in connection with the embodiment can be included in at least one embodiment of the present disclosure. The appearance of this phrase in various places in the specification does not necessarily refer to the same embodiment or an independent or alternative embodiment mutually exclusive with other embodiments. It is understood explicitly and implicitly by those skilled in the art that the embodiments described herein can be combined with other embodiments.

Embodiments of the present disclosure provides a fault monitoring method and apparatus for a sintering device, which can process the state monitoring information by using the state prediction rule to obtain the prediction state information, and then comprehensively process the prediction state information and the state threshold information by using the fault evaluation rule to obtain the fault state information used for instructing to perform intelligent operation and maintenance of the sintering device, which facilitates the precise detection of the operating state of the sintering device and the early warning of a fault in the sintering device, thereby improving the guarantee capability for the intelligent maintenance of the sintering device and the stable operation of the sintering device. Detailed description is as follows.

### Embodiment 1

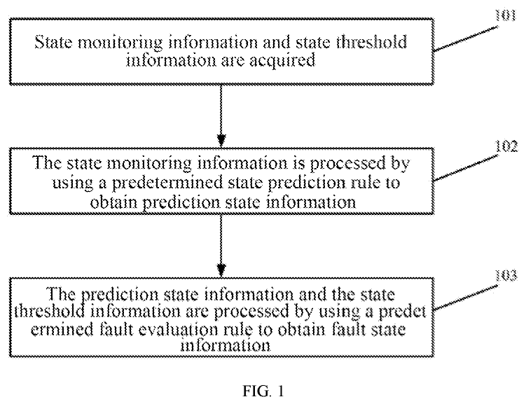

Referring to FIG. 1, a flow schematic diagram of a fault monitoring method for a sintering device according to an embodiment of the present disclosure is shown. The fault monitoring method for the sintering device described in FIG. 1 is applied to a warehouse management system, such as a local server or a cloud server for monitoring and managing a fault in a warehouse logistics sintering device, which is not limited in the embodiment of the present disclosure. As shown in FIG. 1, the fault monitoring method of the sintering device may include the following Steps 101-103.

In Step 101, state monitoring information and state threshold information are acquired.

In Step 102, the state monitoring information is processed by using a predetermined state prediction rule to obtain prediction state information.

In Step 103, the prediction state information and the state threshold information are processed by using a predetermined fault evaluation rule to obtain fault state information.

In the embodiment of the present disclosure, the fault state information is used for instructing to perform intelligent operation and maintenance of a sintering device.

In the embodiment of the present disclosure, the state threshold information includes state reference information and determination threshold information.

In some embodiments, the state monitoring information includes state parameter information of a sintering device, and/or first time sequence information, which is not limited in the embodiment of the present disclosure.

In the embodiment of the present disclosure, the state parameter information of the sintering device includes flow information, and/or current information, and/or pressure information, and/or voltage information, and/or temperature information, which is not limited in the embodiment of the present disclosure.

It can be seen that the fault monitoring method for the sintering device described in the embodiment of the present disclosure can process the state monitoring information by using the state prediction rule to obtain the prediction state information, and then comprehensively process the prediction state information and the state threshold information by using the fault evaluation rule to obtain the fault state information used for instructing to perform intelligent operation and maintenance of the sintering device, which facilitates the precise detection of the operating state of the sintering device and the early warning of a fault in the sintering device, thereby improving the guarantee capability for the intelligent maintenance of the sintering device and the stable operation of the sintering device.

In an embodiment, the state monitoring information includes first time sequence information and actually measured state information.

The processing state monitoring information by using a predetermined state prediction rule to obtain prediction state information in the step 102 includes following steps:
processing the first time sequence information by using a predetermined first prediction model to obtain a first prediction information set; where the first prediction information set includes a plurality of first prediction information;
processing the first time sequence information by using a predetermined second prediction model to obtain a second prediction information set; where the second prediction information set includes a plurality of second prediction information;
processing the first prediction information set, the second prediction information set and the actually measured state information to obtain a weight coefficient set; where the weight coefficient set includes a first weight coefficient and a second weight coefficient;
determining the prediction state information according to the first prediction model, the second prediction model and the weight coefficient set.

In an embodiment, the first prediction model includes an artificial intelligence model based on neural network and/or an artificial intelligence model based on machine learning, which is not limited in the embodiment of the present disclosure.

In an embodiment, the first prediction model is a multilayer feedforward neural network model.

In an embodiment, the number of network layers of the multilayer feedforward neural network model is 3.

In an embodiment, the target error of the multilayer feedforward neural network model is 1/1000.

In an embodiment, the learning rate of the multilayer feedforward neural network model is 3/10.

In an embodiment, the second prediction model includes an artificial intelligence model based on nonlinear state estimation and/or an artificial intelligence model based on machine learning, which is not limited in the embodiment of the present disclosure.

It can be seen that the fault monitoring method for the sintering device described in the embodiment of the present disclosure can process the first time sequence information by using the first prediction model and the second prediction model to obtain the first prediction information and the second prediction information, and then comprehensively process data information to obtain the first weight coefficient and the second weight coefficient and determine the prediction state information, which facilitates the precise detection of the operating state of the sintering device and the early warning of a fault in the sintering device, thereby improving the guarantee capability for the intelligent maintenance of the sintering device and the stable operation of the sintering device.

In another embodiment, the step of processing the first prediction information set, the second prediction information set and the actually measured state information to obtain a weight coefficient set includes following steps:
processing the first prediction information set and the actually measured state information by using a predetermined precision calculation model to obtain a first prediction precision set; where the first prediction precision set includes a plurality of first prediction precision;
processing the second prediction information set and the actually measured state information by using the precision calculation model to obtain a second prediction precision set; wherein the second prediction precision set includes a plurality of second prediction precision;
calculating the first prediction precision set, the first prediction information set, the second prediction precision set and the second prediction information set by using a predetermined combined prediction precision model to obtain combined prediction information; and
processing the combined prediction information and the actually measured state information to obtain a weight coefficient set.

In an embodiment, the specific expression of the precision calculation model is as follow:

$${x}_{it} = \{ \begin{matrix}1 - \vert \frac{\text{?} - {y}_{it}}{\text{?}} \vert , \vert ( {y}_{t} - {y}_{it} ) / \text{?} \vert < 1 \\ 0 , \vert ( \text{?} - {y}_{it} ) / \text{?} \vert \geq 1\end{matrix}$$

$$\text{?} \text{indicates text missing or illegible when filed}$$

where xᵢₜ is the prediction precision, yₜ is the prediction value corresponding to the prediction information, yᵢₜ is the actually measured value in the actually measured state information, i is the sequence number of the prediction model, and t is the ordinal number in the first time sequence information.

In an embodiment, the prediction precision includes the first prediction precision and/or the second prediction precision, which is not limited in the embodiment of the present disclosure.

In an embodiment, the prediction precision is a positive number greater than 0 and less than or equal to 1.

In an embodiment, when i is 1, the prediction model is the first prediction model; and when i is 2, the prediction model is the second prediction model.

In an embodiment, the above combined prediction precision model is a model based on an induced ordered weighted averaging (IOWA) operator.

It can be seen that the fault monitoring method for the sintering device described in the embodiment of the present disclosure can obtain the first prediction precision and the second prediction precision through processing by the precision calculation model, and then comprehensively process data information to obtain the weight coefficient set, which facilitates the precise detection of the operating state of the sintering device and the early warning of a fault in the sintering device, thereby improving the guarantee capability for the intelligent maintenance of the sintering device and the stable operation of the sintering device.

In still another embodiment, the step of processing the combined prediction information and the actually measured state information to obtain a weight coefficient set includes following steps:
performing error calculation on the combined prediction information and the actually measured state information to obtain error value information; and
processing the error value information by using a predetermined minimum value solving rule to obtain a weight coefficient set.

In an embodiment, the error value information includes the difference information between the actually measured state information and the combined prediction information and the relationship information of the weight coefficients.

In an embodiment, the step of processing the error value information by using a predetermined minimum value solving rule to obtain a weight coefficient set specifically includes following steps:
solving the error information by using a model based on fmincon function to obtain a weight matrix; and
solving the weight matrix to obtain a first weight coefficient and a second weight coefficient.

It can be seen that the fault monitoring method for the sintering device described in the embodiment of the present disclosure can calculate errors of the combined prediction information and the actually measured state information to obtain error value information, and process the error value information by using a predetermined minimum value solving rule to obtain a weight coefficient set, which facilitates the precise detection of the operating state of the sintering device and the early warning of a fault in the sintering device, thereby improving the guarantee capability for the intelligent maintenance of the sintering device and the stable operation of the sintering device.

In yet another alternative embodiment, the state threshold information includes second time sequence information.

The step of determining the prediction state information according to the first prediction model, the second prediction model and the weight coefficient set includes following steps:
processing the second time sequence information by using the first prediction model to obtain a first state information set; where the first state information set includes a plurality of first state information;
processing the second time sequence information by using the second prediction model to obtain a second state information set; where the second state information set includes a plurality of second state information;
processing the weight coefficient set, the first state information set and the second state information set to obtain prediction state information.

The prediction state information includes second time sequence information and prediction state value information.

In an embodiment, the second time sequence information includes a plurality of sequence values.

In an embodiment, the prediction state value information includes a plurality of prediction state values.

In an embodiment, any prediction state value corresponds to a unique sequence value.

In the embodiment, as an alternative implementation, the step of processing the weight coefficient set, the first state information set and the second state information set to obtain the prediction state information specifically includes following steps:
for any sequence value in the second time sequence information, determining the first state information in the first state information set, which is matched with the sequence value as a first intermediate information;
determining a second state information in the second state information set, which is matched with the sequence value as a second intermediate information;
determining a product of the first intermediate information and the first weight coefficient as a first weight value;
determining the product of the second intermediate information and the second weight coefficient as a second weight value;
determining the sum of the first weight value and the second weight value as the prediction state value corresponding to the sequence value.

It can be seen that the fault monitoring method for the sintering device described in the embodiment of the present disclosure can process the second time sequence information by using the first prediction model and the second prediction model to obtain the first state information and the second state information, and then comprehensively process the data information to obtain the prediction state information, which facilitates the precise detection of the operating state of the sintering device and the early warning of a fault in the sintering device, thereby improving the guarantee capability for the intelligent maintenance of the sintering device and the stable operation of the sintering device.

### Embodiment 2

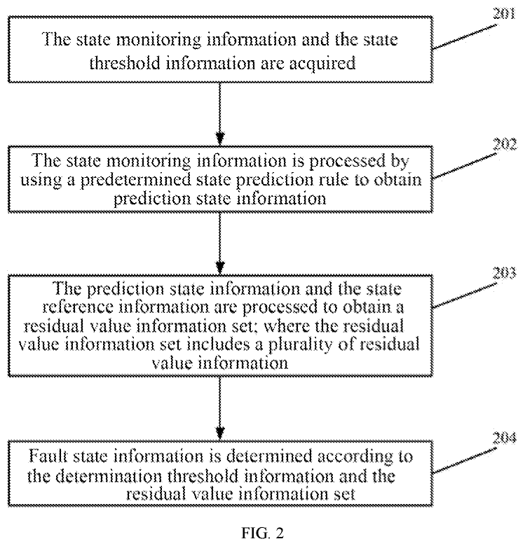

Referring to FIG. 2, a flow schematic diagram of another fault monitoring method for a sintering device according to an embodiment of the present disclosure is shown. The fault monitoring method for the sintering device shown in FIG. 2 is applied to a warehouse management system, such as a local server or a cloud server for monitoring and managing a fault in a warehouse logistics sintering device, which is not limited in the embodiment of the present disclosure. As shown in FIG. 2, the fault monitoring method of the sintering device may include the following steps 201 to 204.

Step 201, the state monitoring information and the state threshold information are acquired.

Step 202, the state monitoring information is processed by using a predetermined state prediction rule to obtain prediction state information.

Step 203, the prediction state information and the state reference information are processed to obtain a residual value information set; where the residual value information set includes a plurality of residual value information.

Step 204, fault state information is determined according to the determination threshold information and the residual value information set.

In the embodiment of the present disclosure, explanations of the specific technical details and technical terms of Step 201 and Step 202 may refer to the detailed description of Step 101 and Step 102 in Embodiment 1, which will not be described in detail in the embodiment of the present disclosure.

In an embodiment, the residual value information includes a sequence value and/or a residual value, which is not limited in the embodiment of the present disclosure.

In an embodiment, the state reference information includes a sequence value and/or a state reference value, which is not limited in the embodiment of the present disclosure.

In the embodiment, as an alternative implementation, the step of processing the prediction state information and the state reference information to obtain the residual value information set specifically includes following steps:
for any prediction state value, calculating the difference between the prediction state value and the state reference value corresponding to the prediction state value as an intermediate difference corresponding to the prediction state value;
determining whether the intermediate difference is great than 0 to obtain a difference determination result; and
when the difference determination result is YES, determining that the intermediate difference is the residual value corresponding to the prediction state value.

It can be seen that the fault monitoring method for the sintering device described in the embodiment of the present disclosure can process the state monitoring information by using the state prediction rule to obtain the prediction state information, and then process the prediction state information and the state reference information by using the fault evaluation rule to obtain the residual value information, and then obtain the fault state information used for instructing to perform intelligent operation and maintenance of the sintering device according to the determination threshold information and the residual value information, which facilitates the precise detection of the operating state of the sintering device and the early warning of a fault in the sintering device, thereby improving the guarantee capability for the intelligent maintenance of the sintering device and the stable operation of the sintering device.

In an alternative embodiment, the determination threshold information includes a first threshold value, a second threshold value and a time sequence interval.

The determining fault state information according to the judgment threshold information and the residual value information set in step 204 includes following steps.
calculating the state reference information and the residual value information set are calculated to obtain a multiple value set; wherein the multiple value set includes a plurality of multiple values;
for any residual value information, determining whether the multiple value corresponding to the residual value information is greater than or equal to the first threshold value to obtain a first determination result;
when the first determination result is YES, determining the fault state information according to the second time sequence information corresponding to the residual value information, and ending current process;
when the first determination result is NO, determining the number of residual values corresponding to the residual value information according to the time sequence interval and the second time sequence information corresponding to the residual value information;
determining whether the number of residual values corresponding to the residual value information is greater than or equal to a second threshold value to obtain a second determination result;
when the second determination result is YES, determining the fault state information according to the second time sequence information corresponding to the residual value information.

In an embodiment, the first threshold value is a positive integer greater than or equal to 1.

in an embodiment, the second threshold value is a positive integer greater than or equal to 3.

In an embodiment, the time sequence interval is related to the sequence value.

It can be seen that the fault monitoring method for the sintering device described in the embodiment of the present disclosure can comprehensively process the residual value information, the first threshold value, the second threshold value and the time sequence interval to obtain the fault state information, which facilitates the precise detection of the operating state of the sintering device and the early warning of a fault in the sintering device, thereby improving the guarantee capability for the intelligent maintenance of the sintering device and the stable operation of the sintering device.

### Embodiment 3

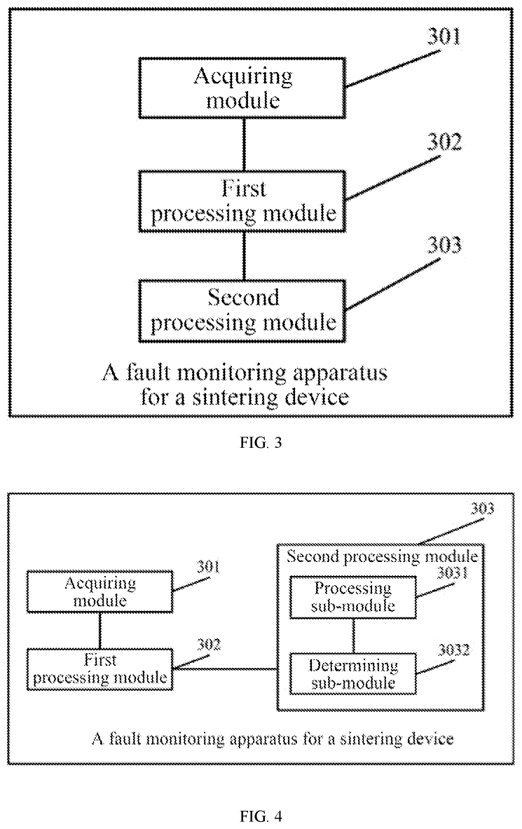

Referring to FIG. 3, a schematic structural diagram of a fault monitoring apparatus for a sintering device according to an embodiment of the present disclosure is shown. The apparatus shown in FIG. 3 can be applied to a warehouse management system, such as a local server or a cloud server for monitoring and managing a fault in a warehouse logistics sintering device, which is not limited in the embodiment of the present disclosure. As shown in FIG. 3, the apparatus may include an acquiring module 301, a first processing module 302 and a second processing module 303.

The acquiring module 301 is configured to acquire state monitoring information and state threshold information.

The first processing module 302 is configured to process the state monitoring information by using a predetermined state prediction rule to obtain prediction state information.

The second processing module 303 is configured to process the prediction state information and the state threshold information by using a predetermined fault evaluation rule to obtain fault state information; where the fault state information is used for instructing to perform intelligent operation and maintenance of a sintering device.

It can be seen that the fault monitoring apparatus for the sintering device described in FIG. 3 can process the state monitoring information by using the state prediction rule to obtain the prediction state information, and then comprehensively process the prediction state information and the state threshold information by using the fault evaluation rule to obtain the fault state information used for instructing to perform intelligent operation and maintenance of the sintering device, which facilitates the precise detection of the operating state of the sintering device and the early warning of a fault in the sintering device, thereby improving the guarantee capability for the intelligent maintenance of the sintering device and the stable operation of the sintering device.

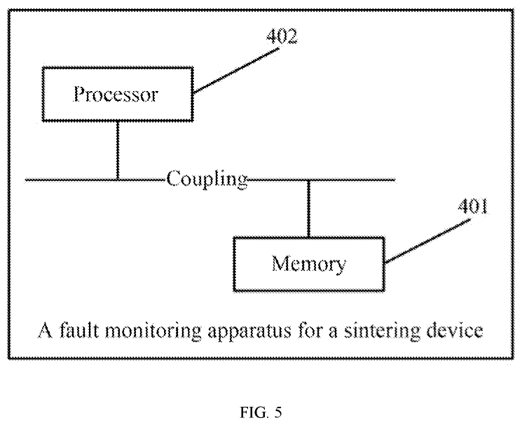

In another alternative embodiment, as shown in FIG. 4, the state monitoring information includes first time sequence information and actually measured state information.

The first processing module 302 is configured to process the state monitoring information by using a predetermined state prediction rule to obtain prediction state information, and is specifically configured to:
process the first time sequence information by using a predetermined first prediction model to obtain a first prediction information set; where the first prediction information set includes a plurality of first prediction information;
process the first time sequence information by using a predetermined second prediction model to obtain a second prediction information set; where the second prediction information set includes a plurality of second prediction information;
process the first prediction information set, the second prediction information set and the actually measured state information to obtain a weight coefficient set; where the weight coefficient set includes a first weight coefficient and a second weight coefficient;
determine the prediction state information according to the first prediction model, the second prediction model and the weight coefficient set.

It can be seen that the fault monitoring apparatus for the sintering device described in FIG. 4 can process the first time sequence information by using the first prediction model and the second prediction model to obtain first prediction information and second prediction information, and then comprehensively process the data information to obtain the first weight coefficient and the second weight coefficient and determine the prediction state information, which facilitates the precise detection of the operating state of the sintering device and the early warning of a fault in the sintering device, thereby improving the guarantee capability for the intelligent maintenance of the sintering device and the stable operation of the sintering device.

In another alternative embodiment, as shown in FIG. 4, the first processing module 302 is configured to process the first prediction information set, the second prediction information set and the actually measured state information to obtain a weight coefficient set, and is specifically configured to:
process the first prediction information set and the actually measured state information by using a predetermined precision calculation model to obtain a first prediction precision set; where the first prediction precision set includes a plurality of first prediction precision;
process the second prediction information set and the actually measured state information by using the precision calculation model to obtain a second prediction precision set; where the second prediction precision set includes a plurality of second prediction precision;
calculate the first prediction precision set, the first prediction information set, the second prediction precision set and the second prediction information set by using a predetermined combined prediction precision model to obtain combined prediction information;
process the combined prediction information and the actually measured state information to obtain a weight coefficient set.

It can be seen that the fault monitoring apparatus for the sintering device described in FIG. 4 can obtain the first prediction precision and the second prediction precision through processing by the precision calculation model, and then comprehensively process the data information to obtain the weight coefficient set, which facilitates the precise detection of the operating state of the sintering device and the early warning of a fault in the sintering device, thereby improving the guarantee capability for the intelligent maintenance of the sintering device and the stable operation of the sintering device.

In another alternative embodiment, as shown in FIG. 4, the first processing module 302 is configured to process the combined prediction information and the actually measured state information to obtain a weight coefficient set, and is specifically configured to:
perform error calculation on the combined prediction information and the actually measured state information to obtain error value information;
process the error value information by using a predetermined minimum value solving rule to obtain a weight coefficient set.

It can be seen that the fault monitoring apparatus for the sintering device described in FIG. 4 can perform error calculation on the combined prediction information and the actually measured state information to obtain error value information, and determine the error value information by using a predetermined minimum value solving rule to obtain a weight coefficient set, which facilitates the precise detection of the operating state of the sintering device and the early warning of a fault in the sintering device, thereby improving the guarantee capability for the intelligent maintenance of the sintering device and the stable operation of the sintering device.

In yet another alternative embodiment, as shown in FIG. 4, the state threshold information includes second time sequence information.

The first processing module 302 is configured to determine the prediction state information according to the first prediction model, the second prediction model and the weight coefficient set, and is specifically configured to:
process the second time sequence information by using the first prediction model to obtain a first state information set; where the first state information set includes a plurality of first state information;
process the second time sequence information by using the second prediction model to obtain a second state information set; where the second state information set includes a plurality of second state information;
process the weight coefficient set, the first state information set and the second state information set to obtain prediction state information.

It can be seen that the fault monitoring apparatus for the sintering device described in FIG. 4 can process the second time sequence information by using the first prediction model and the second prediction model to obtain the first state information and the second state information, and then comprehensively process the data information to obtain the prediction state information, which facilitates the precise detection of the operating state of the sintering device and the early warning of a fault in the sintering device, thereby improving the guarantee capability for the intelligent maintenance of the sintering device and the stable operation of the sintering device.

In yet another alternative embodiment, as shown in FIG. 4, the state threshold information includes state reference information and determination threshold information;
the second processing module 303 includes a processing sub-module 3031 and a determining sub-module 3032, where:
the processing sub-module 3031 is configured to process the prediction state information and the state reference information to obtain a residual value information set; where the residual value information set includes a plurality of residual value information;
the determining sub-module 3032 is configured to determine the fault state information according to the determination threshold information and the residual value information set.

It can be seen that the fault monitoring apparatus for the sintering device described in FIG. 4 can process the state monitoring information by using the state prediction rule to obtain the prediction state information, and then process the prediction state information and the state reference information by using the fault evaluation rule to obtain the residual value information, and then obtain the fault state information used for instructing to perform intelligent operation and maintenance of the sintering device according to the determination threshold information and the residual value information, which facilitates the precise detection of the operating state of the sintering device and the early warning of a fault in the sintering device, thereby improving the guarantee capability for the intelligent maintenance of the sintering device and the stable operation of the sintering device.

In yet another alternative embodiment, as shown in FIG. 4, the determination threshold information includes a first threshold value, a second threshold value and a time sequence interval.

The determining sub-module 3032 is configured to determine the fault state information according to the determination threshold information and the residual value information set, and is specifically configured to:
calculate the state reference information and the residual value information set to obtain a multiple value set; where the multiple value set includes a plurality of multiple values;
for any residual value information, determine whether the multiple value corresponding to the residual value information is greater than or equal to the first threshold value to obtain a first determination result;
when the first determination result is YES, determine the fault state information according to the second time sequence information corresponding to the residual value information, and end current process;
when the first determination result is NO, determine the number of residual values corresponding to the residual value information according to the time sequence interval and the second time sequence information corresponding to the residual value information;
determine whether the number of residual values corresponding to the residual value information is greater than or equal to the second threshold value to obtain a second determination result;
when the second determination result is YES, determine the fault state information according to the second time sequence information corresponding to the residual value information.

It can be seen that the fault monitoring apparatus for the sintering device described in FIG. 4 can comprehensively process the residual value information, the first threshold value, the second threshold value and the time sequence interval to obtain the fault state information, which facilitates the precise detection of the operating state of the sintering device and the early warning of a fault in the sintering device, thereby improving the guarantee capability for the intelligent maintenance of the sintering device and the stable operation of the sintering device.

### Embodiment 4

Referring to FIG. 5, a schematic structural diagram of another fault monitoring apparatus for a sintering device according to an embodiment of the present disclosure is shown. The apparatus shown in FIG. 5 can be applied to a warehouse management system, such as a local server or a cloud server for monitoring and managing a fault in a warehouse logistics sintering device, which is not limited in the embodiment of the present disclosure. As shown in FIG. 5, the apparatus may include:
a memory 401, in which an executable program code is stored;
a processor 402, which is coupled to the memory 401;
where the processor 402 calls the executable program code stored in the memory 401 to execute the steps in the fault monitoring method for the sintering device described in Embodiment 1 or Embodiment 2.

### Embodiment 5

The embodiment of the present disclosure provides a computer-storable medium, which stores a computer program for electronic data exchange, where the computer program causes a computer to execute the steps in the fault monitoring method for the sintering device described in Embodiment 1 or Embodiment 2.

### Embodiment 6

The embodiment of the present disclosure provides a computer program product. The computer program product includes a non-transitory computer-readable storage medium in which a computer program is stored, and the computer program is operable to cause a computer to execute the steps in the fault monitoring method for the sintering device described in Embodiment 1 or Embodiment 2.

The apparatus embodiments described above are only schematic, in which the modules described as separate components may or may not be physically separated, and the components displayed as modules may or may not be physical modules. That is, the components may be located in one place, or may be distributed to a plurality of network modules. Some or all of the modules can be selected according to actual needs to achieve the purpose of this embodiment. Those skilled in the art can understand and implement the purpose without creative labor.

Through the detailed description of the above embodiments, those skilled in the art can clearly understand that each embodiment can be realized by a software plus necessary general hardware platform, and of course can also be realized by hardware. Based on this understanding, the essence of the above technical scheme or the part that has contributed to the prior art can be embodied in the form of a software product. The computer software product can be stored in a computer-readable storage medium. The storage medium includes a Read-Only Memory (ROM), a Random Access Memory (RAM), a Programmable Read-only Memory (PROM), an Erasable Programmable Read-Only Memory (EPROM), an One-time Programmable Read-Only Memory (OTPROM), an Electrically Erasable Programmable Read-Only Memory (EEPROM), a Compact Disc Read-Only Memory (CD-ROM) or other optical disc storages, magnetic disk storages, magnetic tape storages, or any other computer-readable medium that can be used to carry or store data.

Finally, it should be explained that a fault monitoring method and apparatus for a sintering device according to an embodiment of the present disclosure only explain a preferable embodiment of the present disclosure, which is only used to illustrate the technical scheme of the present disclosure, rather than limit the technical scheme. Although the present disclosure has been described in detail with reference to the foregoing embodiments, it should be understood by those skilled in the art that the technical scheme described in the above embodiments can still be modified, or some technical features can be substituted equivalently. However, these modifications or substitutions do not make the essence of the corresponding technical scheme deviate from the spirit and scope of the technical scheme of various embodiments of the present disclosure.

1: A fault monitoring method for a sintering device, comprising:
acquiring state monitoring information and state threshold information;
processing the state monitoring information by using a predetermined state prediction rule to obtain prediction state information; and
processing the prediction state information and the state threshold information by using a predetermined fault evaluation rule to obtain fault state information; wherein the fault state information is used for instructing to perform intelligent operation and maintenance of a sintering device.

2: The fault monitoring method according to claim 1, wherein the state monitoring information comprises first time sequence information and actually measured state information;
the processing the state monitoring information by using a predetermined state prediction rule to obtain prediction state information comprises:
processing the first time sequence information by using a predetermined first prediction model to obtain a first prediction information set; wherein the first prediction information set comprises a plurality of first prediction information;
processing the first time sequence information by using a predetermined second prediction model to obtain a second prediction information set; wherein the second prediction information set comprises a plurality of second prediction information;
processing the first prediction information set, the second prediction information set and the actually measured state information to obtain a weight coefficient set; wherein the weight coefficient set comprises a first weight coefficient and a second weight coefficient; and
determining the prediction state information according to the first prediction model, the second prediction model and the weight coefficient set.

3: The fault monitoring method according to claim 2, the processing the first prediction information set, the second prediction information set and the actually measured state information to obtain a weight coefficient set comprises:
processing the first prediction information set and the actually measured state information by using a predetermined precision calculation model to obtain a first prediction precision set; wherein the first prediction precision set comprises a plurality of first prediction precision;
processing the second prediction information set and the actually measured state information by using the precision calculation model to obtain a second prediction precision set; wherein the second prediction precision set comprises a plurality of second prediction precision;
calculating the first prediction precision set, the first prediction information set, the second prediction precision set and the second prediction information set by using a predetermined combined prediction precision model to obtain combined prediction information;
processing the combined prediction information and the actually measured state information to obtain a weight coefficient set.

4: The fault monitoring method according to claim 3, the processing the combined prediction information and the actually measured state information to obtain a weight coefficient set comprises:
performing error calculation on the combined prediction information and the actually measured state information to obtain error value information;
processing the error value information by using a predetermined minimum value solving rule to obtain a weight coefficient set.

5: The fault monitoring method according to claim 2, wherein the state threshold information comprises second time sequence information;
the determining the prediction state information according to the first prediction model, the second prediction model and the weight coefficient set comprises:
processing the second time sequence information by using the first prediction model to obtain a first state information set; wherein the first state information set comprises a plurality of first state information;
processing the second time sequence information by using the second prediction model to obtain a second state information set; wherein the second state information set comprises a plurality of second state information; and
processing the weight coefficient set, the first state information set and the second state information set to obtain the prediction state information.

6: The fault monitoring method according to claim 1, wherein the state threshold information comprises state reference information and determination threshold information;
the processing the prediction state information and the state threshold information by using a predetermined fault evaluation rule to obtain fault state information comprises:
processing the prediction state information and the state reference information to obtain a residual value information set; wherein the residual value information set comprises a plurality of residual value information; and
determining the fault state information according to the determination threshold information and the residual value information set.

7: The fault monitoring method according to claim 6, wherein the determination threshold information comprises a first threshold value, a second threshold value and a time sequence interval;
the determining the fault state information according to the determination threshold information and the residual value information set comprises:
calculating the state reference information and the residual value information set to obtain a multiple value set; wherein the multiple value set comprises a plurality of multiple values;
for any residual value information, determining whether the multiple value corresponding to the residual value information is greater than or equal to the first threshold value to obtain a first determination result;
when the first determination result is YES, determining the fault state information according to the second time sequence information corresponding to the residual value information, and ending current process;
when the first determination result is NO, determining the number of residual values corresponding to the residual value information according to the time sequence interval and the second time sequence information corresponding to the residual value information;
determining whether the number of residual values corresponding to the residual value information is greater than or equal to the second threshold value to obtain a second determination result; and
when the second determination result is YES, determining the fault state information according to the second time sequence information corresponding to the residual value information.

8: A fault monitoring apparatus for a sintering device, comprising:
an acquiring module, configured to acquire state monitoring information and state threshold information;
a first processing module, configured to process the state monitoring information by using a predetermined state prediction rule to obtain prediction state information; and
a second processing module, configured to process the prediction state information and the state threshold information by using a predetermined fault evaluation rule to obtain fault state information; wherein the fault state information is used for instructing to perform intelligent operation and maintenance of a sintering device.

9: A fault monitoring apparatus for a sintering device, comprising:
a memory, in which an executable program code is stored;
a processor, which is coupled to the memory;
wherein the processor calls the executable program code stored in the memory to execute the fault monitoring method for the sintering device according to claim 1.

10: A computer-storable medium, wherein the computer-storable medium stores computer instructions which, when called, are used to execute the fault monitoring method for the sintering device according to claim 1.

11: The fault monitoring apparatus according to claim 9, wherein the state monitoring information comprises first time sequence information and actually measured state information;
the processing the state monitoring information by using a predetermined state prediction rule to obtain prediction state information comprises:
processing the first time sequence information by using a predetermined first prediction model to obtain a first prediction information set; wherein the first prediction information set comprises a plurality of first prediction information;
processing the first time sequence information by using a predetermined second prediction model to obtain a second prediction information set; wherein the second prediction information set comprises a plurality of second prediction information;
processing the first prediction information set, the second prediction information set and the actually measured state information to obtain a weight coefficient set; wherein the weight coefficient set comprises a first weight coefficient and a second weight coefficient; and
determining the prediction state information according to the first prediction model, the second prediction model and the weight coefficient set.

12: The fault monitoring apparatus according to claim 11, the processing the first prediction information set, the second prediction information set and the actually measured state information to obtain a weight coefficient set comprises:
processing the first prediction information set and the actually measured state information by using a predetermined precision calculation model to obtain a first prediction precision set; wherein the first prediction precision set comprises a plurality of first prediction precision;
processing the second prediction information set and the actually measured state information by using the precision calculation model to obtain a second prediction precision set; wherein the second prediction precision set comprises a plurality of second prediction precision;
calculating the first prediction precision set, the first prediction information set, the second prediction precision set and the second prediction information set by using a predetermined combined prediction precision model to obtain combined prediction information;
processing the combined prediction information and the actually measured state information to obtain a weight coefficient set.

13: The fault monitoring apparatus according to claim 12, the processing the combined prediction information and the actually measured state information to obtain a weight coefficient set comprises:
performing error calculation on the combined prediction information and the actually measured state information to obtain error value information;
processing the error value information by using a predetermined minimum value solving rule to obtain a weight coefficient set.

14: The fault monitoring apparatus according to claim 11, wherein the state threshold information comprises second time sequence information;
the determining the prediction state information according to the first prediction model, the second prediction model and the weight coefficient set comprises:
processing the second time sequence information by using the first prediction model to obtain a first state information set; wherein the first state information set comprises a plurality of first state information;
processing the second time sequence information by using the second prediction model to obtain a second state information set; wherein the second state information set comprises a plurality of second state information; and
processing the weight coefficient set, the first state information set and the second state information set to obtain the prediction state information.

15: The fault monitoring apparatus according to claim 9, wherein the state threshold information comprises state reference information and determination threshold information;
the processing the prediction state information and the state threshold information by using a predetermined fault evaluation rule to obtain fault state information comprises:
processing the prediction state information and the state reference information to obtain a residual value information set; wherein the residual value information set comprises a plurality of residual value information; and
determining the fault state information according to the determination threshold information and the residual value information set.

16: The fault monitoring apparatus according to claim 15, wherein the determination threshold information comprises a first threshold value, a second threshold value and a time sequence interval;
the determining the fault state information according to the determination threshold information and the residual value information set comprises:
calculating the state reference information and the residual value information set to obtain a multiple value set; wherein the multiple value set comprises a plurality of multiple values;
for any residual value information, determining whether the multiple value corresponding to the residual value information is greater than or equal to the first threshold value to obtain a first determination result;
when the first determination result is YES, determining the fault state information according to the second time sequence information corresponding to the residual value information, and ending current process;
when the first determination result is NO, determining the number of residual values corresponding to the residual value information according to the time sequence interval and the second time sequence information corresponding to the residual value information;
determining whether the number of residual values corresponding to the residual value information is greater than or equal to the second threshold value to obtain a second determination result; and
when the second determination result is YES, determining the fault state information according to the second time sequence information corresponding to the residual value information.

17: The computer-storable medium according to claim 10, wherein the state monitoring information comprises first time sequence information and actually measured state information;
the processing the state monitoring information by using a predetermined state prediction rule to obtain prediction state information comprises:
processing the first time sequence information by using a predetermined first prediction model to obtain a first prediction information set; wherein the first prediction information set comprises a plurality of first prediction information;
processing the first time sequence information by using a predetermined second prediction model to obtain a second prediction information set; wherein the second prediction information set comprises a plurality of second prediction information;
processing the first prediction information set, the second prediction information set and the actually measured state information to obtain a weight coefficient set; wherein the weight coefficient set comprises a first weight coefficient and a second weight coefficient; and
determining the prediction state information according to the first prediction model, the second prediction model and the weight coefficient set.

18: The computer-storable medium according to claim 17, the processing the first prediction information set, the second prediction information set and the actually measured state information to obtain a weight coefficient set comprises:
processing the first prediction information set and the actually measured state information by using a predetermined precision calculation model to obtain a first prediction precision set; wherein the first prediction precision set comprises a plurality of first prediction precision;
processing the second prediction information set and the actually measured state information by using the precision calculation model to obtain a second prediction precision set; wherein the second prediction precision set comprises a plurality of second prediction precision;
calculating the first prediction precision set, the first prediction information set, the second prediction precision set and the second prediction information set by using a predetermined combined prediction precision model to obtain combined prediction information;
processing the combined prediction information and the actually measured state information to obtain a weight coefficient set.

19: The computer-storable medium according to claim 18, the processing the combined prediction information and the actually measured state information to obtain a weight coefficient set comprises:
performing error calculation on the combined prediction information and the actually measured state information to obtain error value information;
processing the error value information by using a predetermined minimum value solving rule to obtain a weight coefficient set.

20: The computer-storable medium according to claim 17, wherein the state threshold information comprises second time sequence information;
the determining the prediction state information according to the first prediction model, the second prediction model and the weight coefficient set comprises:
processing the second time sequence information by using the first prediction model to obtain a first state information set; wherein the first state information set comprises a plurality of first state information;
processing the second time sequence information by using the second prediction model to obtain a second state information set; wherein the second state information set comprises a plurality of second state information; and
processing the weight coefficient set, the first state information set and the second state information set to obtain the prediction state information.
